(19) United States
(12) Patent Application Publication
(10) Pub. No.: US 2012/0278354 A1
(43) Pub. Date: Nov. 1, 2012

(54) USER ANALYSIS THROUGH USER LOG FEATURE EXTRACTION

(75) Inventors: Shengquan Yan, Issaquah, WA (US); Zhenghao Wang, Redmond, WA (US); Xiao Huang, Seattle, WA (US); Yu Chen, Sammamish, WA (US); An Yan, Sammamish, WA (US); Jeffrey Eric Larsson, Kirkland, WA (US); Michael Kiogora Kinoti, Seattle, WA (US); Peng Yu, Bellevue, WA (US); Zijian Zheng, Bellevue, WA (US)

(73) Assignee: MICROSOFT CORPORATION, Redmond, WA (US)

(21) Appl. No.: 13/097,277

(22) Filed: Apr. 29, 2011

(51) Int. Cl. G06F 17/30

(52) U.S. Cl. 707/769; 707/E17.014

(57) ABSTRACT

Systems, methods, and computer media for efficiently processing user log data are provided. A received user log data analysis request specifies: target user log features that identify users in a target user group, analysis user log features that identify data associated with the users in the target user group, and an analysis to perform on the identified data associated with the users in the target user group. Occurrences of specified features are extracted from user logs and stored. Users associated with an occurrence of each of the extracted and stored target user log features are identified as users in the target user group. Occurrences of the analysis user log features that are associated with a user in the target user group are extracted and reformatted for the analysis specified in the analysis request.

### BACKGROUND

Internet searching and browsing has become increasingly common in recent years. In an effort to provide targeted services and advertisements, search providers gather a variety of data related to user activity, including received user search queries. Such data is typically stored in user logs, which can easily contain terabytes of information for a single day and multiple petabytes of information overall. The extremely large size of user logs makes analyzing user log data a resource-intensive process. Conventionally, analyzing user log data requires a computationally intensive scan of entire user logs to identify data having particular desired features. Much of the effort in scanning the user logs is directed at reading features in which the analyst conducting the analysis is not interested. Although distributed processing systems can improve performance of conventional user log analysis, the analysis still requires vast and expensive resources.

### SUMMARY

Embodiments of the present invention relate to systems, methods, and computer media for efficiently processing user log data. Using the systems and methods described herein, a user log data analysis request is received. The request specifies: (1) one or more target user log features that identify users in a target user group, (2) one or more analysis user log features that identify data associated with the users in the target user group, and (3) an analysis to perform on the identified data associated with the users in the target user group. Occurrences of the one or more target user log features and occurrences of the one or more analysis user log features are extracted from one or more user logs. The extracted occurrences are stored. Users associated with a stored occurrence of each of the one or more target user log features are identified as users in the target user group. Analysis occurrences are extracted from the stored occurrences. Analysis occurrences are occurrences of the one or more analysis user log features that are associated with a user in the target user group. The extracted analysis occurrences are reformatted for the analysis specified in the analysis request.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary efficient user log data processing system in accordance with embodiments of the present invention;

FIG. 3 is a flow chart of an exemplary method for efficiently processing user log data in accordance with an embodiment of the present invention;

FIG. 4 is a flow chart illustrating an exemplary method for performing occurrence extraction step 304 in FIG. 3;

FIG. 5 is a flow chart of another exemplary method for efficiently processing user log data in accordance with an embodiment of the present invention; and

FIG. 6 is a flow chart illustrating an exemplary method for performing steps 512-518 in FIG. 5.

### DETAILED DESCRIPTION

Embodiments of the present invention are described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” or “module” etc. might be used herein to connote different components of methods or systems employed, the terms should not be interpreted as implying any particular order among or between various steps herein disclosed unless and except when the order of individual steps is explicitly described.

Embodiments of the present invention relate to systems, methods, and computer media for efficiently processing user log data. In accordance with embodiments of the present invention, user log features desired for performing an analysis are identified in one or more user logs, extracted, stored, and reformatted for a specified analysis.

As discussed above, user logs, including search logs, often contain terabytes of data for a single day and petabytes of data for an entire log, making user log data analysis a resource-intensive process. Conventional user log data analysis requires a computationally intensive scan of entire user logs to identify data having particular desired features, with much of the effort directed at reading features in which the analyst conducting the analysis is not interested.

Extracting, storing, and reformatting data related to desired features allows efficient analyses, reuse of extracted data, and increased automation and resource sharing. A user log data analysis request is received that specifies target user log features, analysis user log features, and an analysis to be performed. In many instances, the user log data analysis request is submitted by an analyst or automated system of the search provider. Occurrences of the specified features are extracted from user logs and stored. Extracted and stored occurrences remain available for future analysis requests.

The target user log features are used to identify a target group of users about whom information is desired. The analysis user log features are used to identify data associated with the users in the target user group. For example, an analyst may be interested in first identifying a target user group of users who meet a minimum session count in a particular time period. The analyst may then be interested in performing an analysis on the target user group that considers a different feature such as a particular number of distinct queries. Occurrences of the analysis user log features associated with the users in the target user group are then reformatted for the analysis specified in the analysis request. For example, the occurrences may be reformatted into a time-series dataset for each target user, and each time-series dataset may be aggregated based on the specified analysis.

In one embodiment of the present invention, a user log data analysis request is received. The request specifies: (1) one or more target user log features that identify users in a target user group, (2) one or more analysis user log features that identify data associated with the users in the target user group, and (3) an analysis to perform on the identified data associated with the users in the target user group. Occurrences of the one or more target user log features and occurrences of the one or more analysis user log features are extracted from one or more user logs. The extracted occurrences are stored. Users associated with a stored occurrence of each of the one or more target user log features are identified as users in the target user group. Analysis occurrences are extracted from the stored occurrences. Analysis occurrences are occurrences of the one or more analysis user log features that are associated with a user in the target user group. The extracted analysis occurrences are reformatted for the analysis specified in the analysis request.

In another embodiment, an intake component receives a user log data analysis request specifying: (1) one or more target user log features that identify users in a target user group, (2) one or more analysis user log features that identify data associated with the users in the target user group, and (3) an analysis to perform on the identified data associated with the users in the target user group. An extraction component extracts and stores, from one or more user logs, occurrences of the one or more target user log features and occurrences of the one or more analysis user log features specified by the user log data analysis request. A feature database stores metadata describing extracted and stored occurrences of user log features.

A grouping component identifies, as users in the target user group, users associated with a stored occurrence of each of the one or more target user log features. The users in the target user group are identified from the metadata stored in the feature database. An analysis extraction component extracts analysis occurrences from the stored occurrences. The analysis occurrences are occurrences of the one or more analysis user log features that are associated with a user in the target user group. A reformatting component that reformats the extracted analysis occurrences for the analysis specified in the analysis request.

In still another embodiment, a user log data analysis request is received. The request specifies: (1) one or more target user log features and a first time range that identify users in a target user group, (2) one or more analysis user log features and a second time range that identify data associated with the users in the target user group, and (3) an analysis to perform on the identified data associated with the users in the target user group. Upon determining that occurrences of one or more of the target user log features in the first time range or occurrences of one or more of the analysis user log features in the second time range are not already stored, the occurrences not already stored are extracted from one or more user logs. The extracted occurrences are stored. Metadata describing the extracted and stored occurrences are stored in a feature database. The metadata include a feature name, time, data source, extracted storage location, and user ID.

Users with a corresponding user ID associated with at least one occurrence of each of the one or more target user log features in the first time range are identified as users in the target user group. The users in the target user group are identified from the metadata stored in the feature database. Stored analysis occurrences are extracted from the feature database upon identifying the users in the target user group. Analysis occurrences are occurrences of the analysis user log features in the second time range associated with the user IDs corresponding to the users in the target user group. For each user in the target user group, the extracted analysis occurrences are reformatted into a time-series dataset. The time-series datasets are aggregated based on the specified analysis.

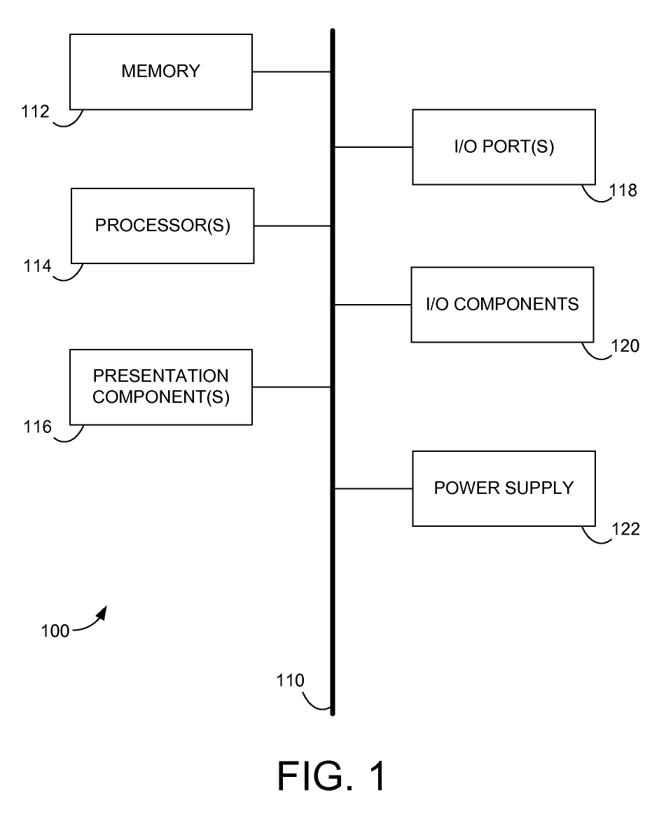

Having briefly described an overview of some embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of embodiments of the present invention. Neither should the computing device 100 be interpreted as having any dependency or requirement relating to any one or combination of components illustrated.

Embodiments of the present invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the present invention may be practiced in a variety of system configurations, including hand-held devices, consumer electronics, general-purpose computers, more specialty computing devices, etc. Embodiments of the present invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100.

Communication media typically embodies computer-readable instructions, data structures, program modules, or other data in a modulated data signal such as a carrier wave. The term “modulated data signal” refers to a propagated signal that has one or more of its characteristics set or changed to encode information in the signal. By way of example, and not limitation, communication media includes wired media, such as a wired network or direct-wired connection, and wireless media such as acoustic, RF, infrared, radio, microwave, spread-spectrum, and other wireless media. Combinations of the above are included within the scope of computer-readable media.

Memory 112 includes computer storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

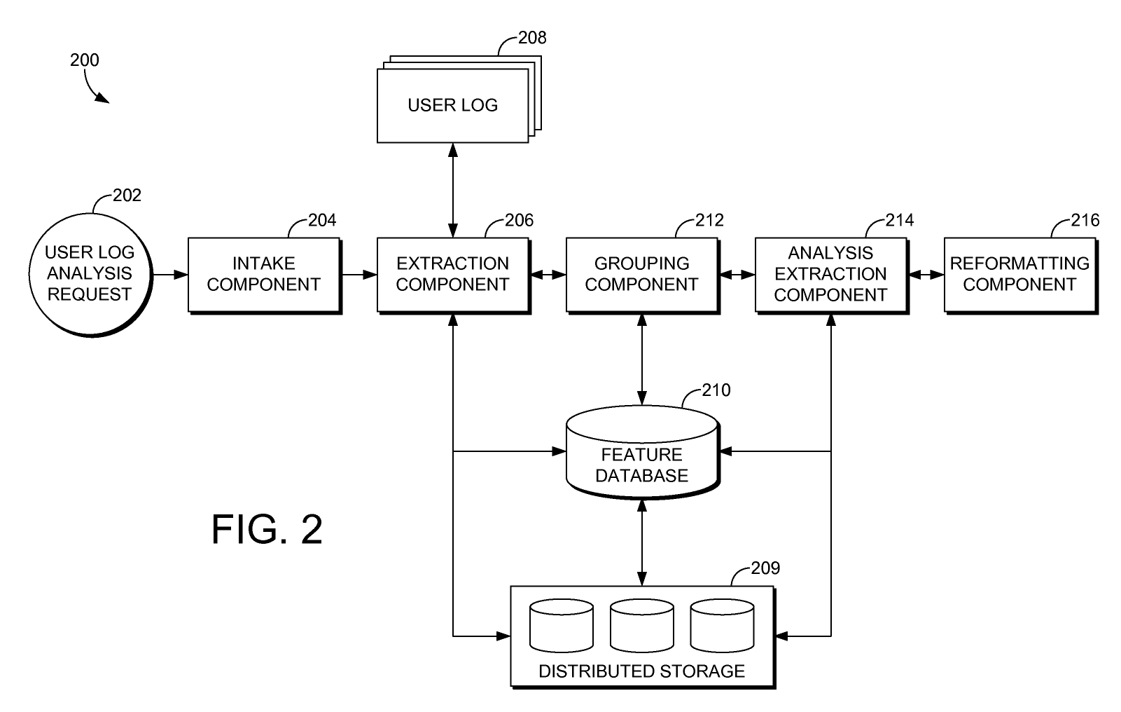

As discussed previously, embodiments of the present invention relate to systems, methods, and computer media for efficiently processing user log data. Embodiments of the present invention will be discussed with reference to FIGS. 2-6.

FIG. 2 is a block diagram illustrating an exemplary efficient user log data processing system 200. User log analysis request 202 is received by intake component 204. User log analysis request 202 includes one or more target user log features that identify users in a target user group. A target user group is a group of users identified for analysis purposes. That is, a target user group is identified so that an analysis can be conducted on the data associated with the members of the group. User log analysis request 202 also includes one or more analysis user log features that identify data associated with the users in the target user group.

As used herein, a user log is a record of user's interactions with a system. User logs include search logs, browser logs, mobile device logs, and other logs. User logs record a variety of information regarding a user's interaction with the system. This information is stored as user log features. As used herein, a user log feature is information related to a user or the user's interaction with a system, such as a search system, that is recorded in a user log. Thousands of user log features are contemplated. A user log feature can represent any aspect of the user or the user's search or other activity. Exemplary user log features include: the IP address of the user; the date that a client cookie was created; the search domain for a page view; the form name for a current page view; partner code for a current page view; the market of the results served to the user; the name of the current page being viewed; the date and/or time a page view request is received; the unmodified query from a request; a number identifying a user visit session; number of sessions in a time period; and whether or not the query is a distinct query in a user's search session. User log features may be defined in a programming or database language such as structured query language (SQL) such that an occurrence of a user log feature associated with a user or the user's activity is a value or string.

The difference between target user log features and analysis user log features is what the features are used for. For example, “whether or not the query is a distinct query in a user's search session” is a target user log feature when it is used to identify the target user group, but this feature is an analysis user log feature when it is used to identify data associated with the users in the target user group. In some embodiments, the target user log features are different from the analysis user log features. For example, it may be desired to first identify a target user group of all users who have an associated occurrence of a target user log feature (e.g., session count) and then perform an analysis that considers one or more analysis user log features (e.g., unique sessions) that are different from the features used to identify the target user group.

Extraction component 206 extracts, from one or more user logs 208, occurrences of the one or more target user log features and occurrences of the one or more analysis user log features specified by user log data analysis request 202. User logs 208 may be raw search logs, merged logs, specific browser logs, mobile device logs, or other user logs. In some embodiments, user logs 208 includes a plurality of daily user logs. Extracted occurrences of user log features, both target user log features and analysis user log features, are stored in distributed storage 209. The storage space in distributed storage 209 may be spread among many physical computing devices in one or more geographic locations. Distributed storage and processing allows for more efficient use of large amounts of data than if the data were stored on one device. In some embodiments, only the occurrences of the one or more target user log features and the occurrences of the one or more analysis user log features not already stored in distributed storage 209 are extracted from user logs 208 by extraction component 206. In such embodiments, extraction component 206 first determines what is already stored prior to extracting occurrences of features to eliminate unnecessary extraction.

Feature database 210 stores metadata describing the extracted and stored occurrences. In some embodiments, the metadata include a feature name, time, data source, extracted storage location, and user ID. The user ID may be a cookie-based user ID. Grouping component 212 identifies, as users in the target user group, users associated with a stored occurrence of each of the one or more target user log features. The stored occurrences are stored in distributed storage 209. The users in the target user group are identified from the metadata stored in feature database 210. The relatively small storage size of the metadata stored in feature database 210 makes using the metadata to identify the users in the target user group less resource-intensive than using either tera- or petabytes of user log data in raw log form or using the extracted occurrences stored in distributed storage 209.

Analysis extraction component 214 extracts analysis occurrences from distributed storage 209. Analysis occurrences are occurrences of the one or more analysis user log features that are associated with a user in the target user group. Thus, now that the target group of users has been identified and occurrences of all desired features have been extracted from user log 208 or are already present in distributed storage 209, occurrences of the analysis user log features that will be used in the analysis specified in user log analysis request 202 are extracted from distributed storage 209. Reformatting component 216 then reformats the extracted analysis occurrences for the analysis specified in user log analysis request 202. Analysis can then be performed on the data (reformatted extracted occurrences) associated with the users in the target user group.

In other embodiments, reformatting component 216 reformats the analysis occurrences extracted by analysis extraction component 214 into a time-series dataset for each of the users in the target user group. The time-series dataset may be formatted such that time is on the y-axis and occurrences of features are on the x-axis. In many instances, time-series data allows for more efficient analysis. The reformatting component may also aggregate one or more of the time-series datasets based on the specified analysis. For example, the analysis specified in user log analysis request 202 may require the number of distinct queries during all of a user's sessions in a particular day. The time-series dataset for the user may indicate individual distinct queries during a particular session. Aggregation will combine the individual distinct queries into the desired metric of number of distinct queries during all of a user's sessions in the particular day.

In still other embodiments, user log data analysis request 202 also specifies a first time range for the one or more target user log features and a second time range for the one or more analysis user log features. In such embodiments, the users identified by grouping component 212 as being in the target user group are associated with an occurrence of each of the one or more target user log features in the first time range, and the analysis occurrences extracted by analysis extraction component 214 are occurrences of the one or more analysis user log features in the second time range that are associated with a user in the target user group.

As discussed above, user logs 208 may include a plurality of daily user logs. In some embodiments, extraction component 206 extracts occurrences from two or more of the plurality of daily user logs and merges the occurrences extracted from each daily user log.

In some embodiments, user log analysis request 202 includes one or more sources, such as specific user logs, of the desired occurrences of the target user log features and/or analysis user log features. In other embodiments, user log analysis request 202 specifies one or more additional analyses and corresponding analysis user log features. In such embodiments, for each additional analysis and corresponding analysis user log features, analysis occurrences are extracted and reformatted for the analysis.

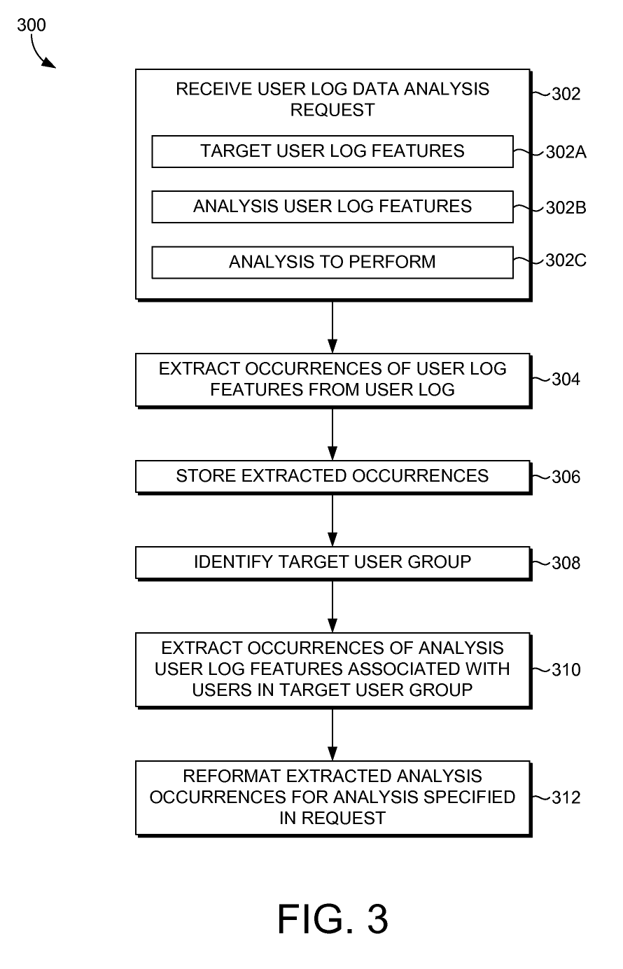

FIG. 3 illustrates an exemplary method 300 for efficiently processing user log data. A user log data analysis request is received in step 302. The request specifies one or more target user log features 302A that identify users in a target user group, one or more analysis user log features 302B that identify data associated with the users in the target user group, and an analysis 302C to perform on data associated with the users in the target user group. In step 304, occurrences of the one or more target user log features and occurrences of the one or more analysis user log features are extracted from one or more user logs. The extracted occurrences are stored in step 306. The extracted occurrences may be stored in a distributed storage system.

A target user group is identified in step 308. Users in the target user group are associated with a stored occurrence of each of the one or more target user log features. Analysis occurrences are extracted from the stored occurrences in step 310. Analysis occurrences are occurrences of the one or more analysis user log features that are associated with a user in the target user group. The extracted analysis occurrences are formatted for the analysis specified in the analysis request in step 312.

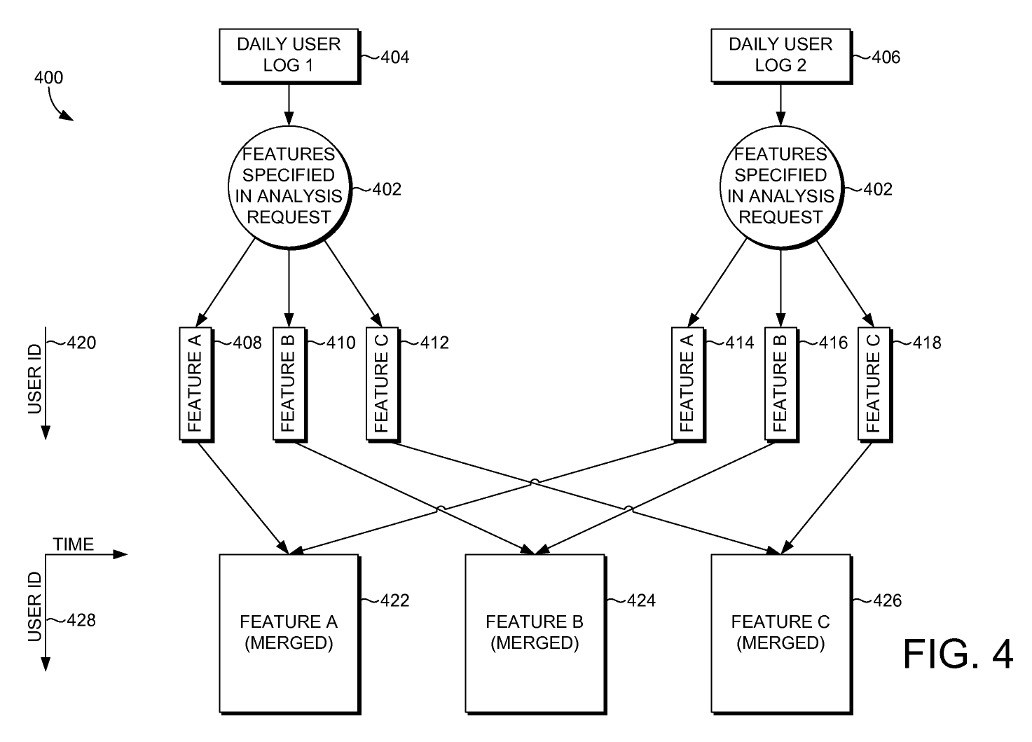

FIG. 4 illustrates an exemplary method 400 for performing occurrence extraction step 304 in FIG. 3. Occurrences 402 of features are extracted from daily user log 1 404 and daily user log 2 406. The extracted features are those specified in an analysis request. Occurrences 408 of Feature A, 410 of Feature B, and 412 of Feature C are extracted from daily user log 1 404. Similarly, occurrences 414 of Feature A, 416 of Feature B, and 418 of Feature C are extracted from daily user log 2 406. As indicated by legend 420, the extracted occurrences are arranged by user ID. In some embodiments, a time for each occurrence is also included.

Occurrences 408 of Feature A from daily user log 1 404 are merged with occurrences 414 of Feature A from daily user log 2 406 to form merged extracted occurrences 422 of Feature A. Similarly, occurrences 410 and 416 merge to form merged extracted occurrences 424 of Feature B, and occurrences 412 and 418 merge to form merged extracted occurrences 426 of Feature C. Each of the merged extracted occurrences now includes feature occurrences for two different days, extracted from daily user log 1 404 and daily user log 2 406. Legend 428 indicates that merged extracted occurrences 422, 424, and 426 are arranged by user ID and time. In some embodiments, merged extracted occurrences 422, 424, and 426 are stored in the format indicated by legend 428 in the feature database.

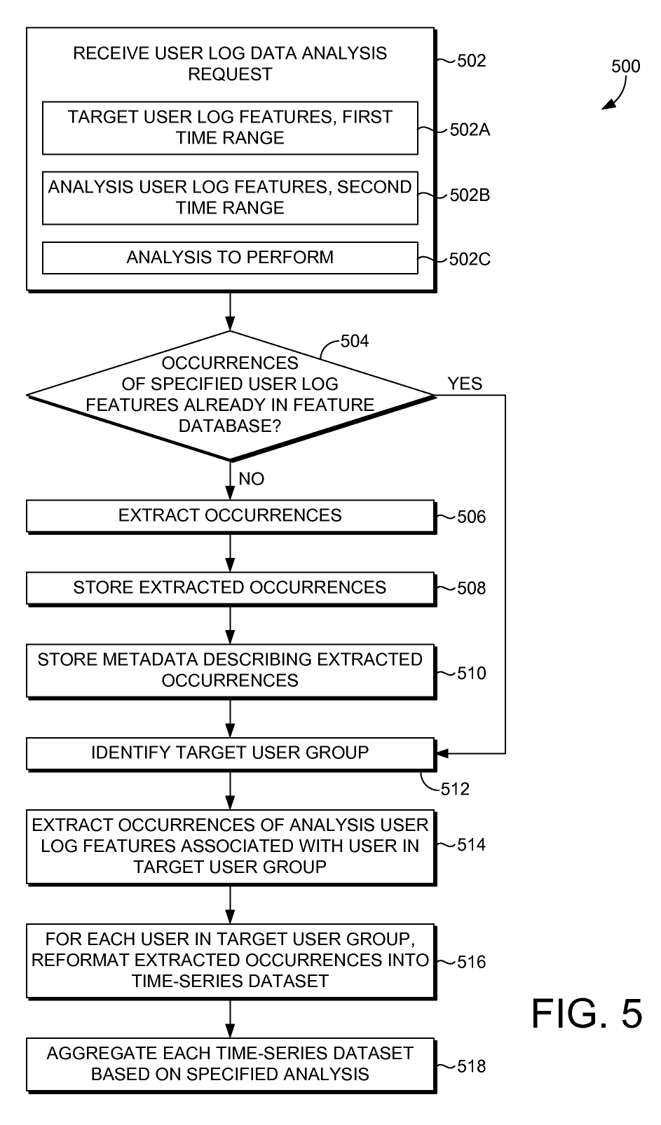

FIG. 5 illustrates another exemplary method 500 for efficiently processing user log data in accordance with an embodiment of the present invention. A user log data analysis request is received in step 502. The request specifies one or more target user log features and a first time range 502A that identify users in a target user group, one or more analysis user log features and a second time range 502B that identify data associated with the users in the target user group, and an analysis 502C to perform on data associated with the users in the target user group. In step 504, it is determined if occurrences of user log features specified in the received request are already stored in the feature database. If the occurrences are already stored in the feature database, method 500 proceeds to step 510.

If the occurrences of one or more of the target user log features in the first time range or occurrences of one or more of the analysis user log features in the second time range are not already stored, however, the occurrences not already stored are extracted from one or more user logs in step 506. In step 508, the extracted occurrences are stored. In step 510, metadata describing the occurrences extracted and stored in steps 506 and 508 are stored in a feature database. The metadata may include a feature name, time, data source, extracted storage location, and user ID. In step 512, users with a corresponding user ID associated with at least one occurrence of each of the one or more target user log features in the first time range are identified as users in the target user group. The users in the target group are identified from the metadata stored in the feature database.

Upon identifying the users in the target user group, stored analysis occurrences are extracted in step 514. The analysis occurrences are occurrences of the analysis user log features in the second time range associated with the user IDs corresponding to the users in the target user group. In step 516, for each user in the target user group, the extracted analysis occurrences are reformatted into a time-series dataset. In step 518, each time-series dataset is aggregated based on the specified analysis 502C.

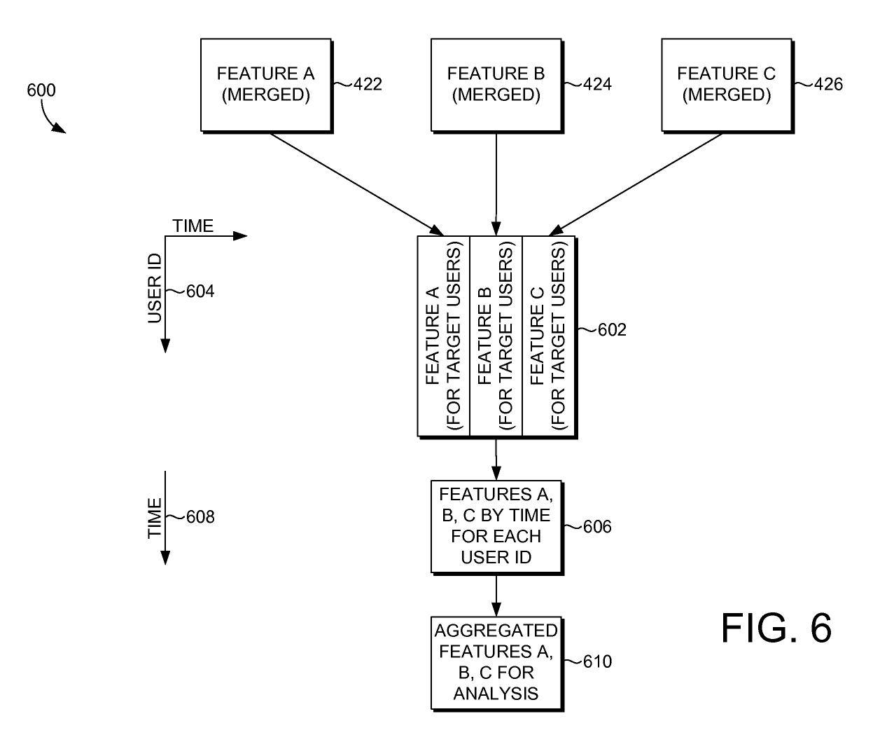

FIG. 6 illustrates an exemplary method 600 for performing steps 512-518 in FIG. 5. Analysis occurrences 602 are extracted from merged extracted occurrences of Feature A 422, Feature B 424, and Feature C 426. In FIG. 6, the analysis user log features specified in the user log data analysis request are Features A, B, and C. As indicated by legend 604, the analysis occurrences of each of Feature A, B, and C are stored according to user ID and time. The analysis occurrences are occurrences of the features A, B, and C in the second time range associated with the user IDs corresponding to the users in the target user group. Time-series datasets 606 include the analysis occurrences of users in the target user group extracted in step 514 of FIG. 5. Legend 608 indicates that Features A, B, and C are arranged by time. A time-series dataset is created for each user ID. Aggregated time-series datasets 610 are the time-series datasets 606 aggregated based on the specified analysis.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

Having thus described the invention, what is claimed is:

1. One or more computer-readable media storing computer-executable instructions for performing a method for efficiently processing user log data, the method comprising:
receiving a user log data analysis request specifying: (1) one or more target user log features that identify users in a target user group, (2) one or more analysis user log features that identify data associated with the users in the target user group, and (3) an analysis to perform on the identified data associated with the users in the target user group;
extracting, from one or more user logs, occurrences of the one or more target user log features and occurrences of the one or more analysis user log features;
storing the extracted occurrences;
identifying, as users in the target user group, users associated with a stored occurrence of each of the one or more target user log features;
extracting analysis occurrences from the stored occurrences, wherein analysis occurrences are occurrences of the one or more analysis user log features that are associated with a user in the target user group; and
reformatting the extracted analysis occurrences for the analysis specified in the analysis request.

2. The media of claim 1, wherein the received user log data analysis request also specifies a first time range for the one or more target user log features and a second time range for the one or more analysis user log features, and wherein the identified users in the target user group are associated with an occurrence of each of the one or more target user log features in the first time range, and wherein analysis occurrences are occurrences of the one or more analysis user log features in the second time range that are associated with a user in the target user group.

3. The media of claim 2, wherein the first time range is different from the second time range.

4. The media of claim 1, wherein the one or more analysis user log features include at least one user log feature different from the one or more target user log features.

5. The media of claim 1, wherein only the occurrences of the one or more target user log features and the occurrences of the one or more analysis user log features not already stored are extracted from the one or more user logs.

6. The media of claim 1, wherein the received user log data analysis request specifies one or more additional analyses and corresponding analysis user log features, and wherein for each additional analysis and corresponding analysis user log features, analysis occurrences are extracted and reformatted for the analysis.

7. The media of claim 1, wherein the one or more user logs includes a plurality of daily user logs, and wherein extracting, from one or more user logs, occurrences of the one or more target user log features and occurrences of the one or more analysis user log features comprises extracting occurrences from two or more of the plurality of daily user logs and merging the occurrences extracted from each daily user log.

8. The media of claim 1, wherein metadata describing the extracted occurrences are stored in a feature database, the metadata including a feature name, time, data source, extracted storage location, and user ID.

9. The media of claim 8, wherein reformatting the extracted analysis occurrences comprises reformatting the extracted analysis occurrences into a time-series dataset for each of the users in the target user group.

10. The media of claim 9, wherein reformatting the extracted analysis occurrences further comprises aggregating one or more of the time-series datasets based on the specified analysis.

11. One or more computer storage media having a system embodied thereon including computer-executable instructions that, when executed, perform a method for efficiently processing user log data, the system comprising:
an intake component that receives a user log data analysis request specifying: (1) one or more target user log features that identify users in a target user group, (2) one or more analysis user log features that identify data associated with the users in the target user group, and (3) an analysis to perform on the identified data associated with the users in the target user group;
an extraction component that extracts and stores, from one or more user logs, occurrences of the one or more target user log features and occurrences of the one or more analysis user log features specified by the user log data analysis request;
a feature database storing metadata describing extracted and stored occurrences of user log features;
a grouping component that identifies, as users in the target user group, users associated with a stored occurrence of each of the one or more target user log features, the users in the target user group identified from the metadata stored in the feature database;
an analysis extraction component that extracts stored analysis occurrences, wherein analysis occurrences are occurrences of the one or more analysis user log features that are associated with a user in the target user group; and
a reformatting component that reformats the extracted analysis occurrences for the analysis specified in the analysis request.

12. The media of claim 11, wherein the user log data analysis request received by the intake component also specifies a first time range for the one or more target user log features and a second time range for the one or more analysis user log features, and wherein the users identified by the grouping component as being in the target user group are associated with an occurrence of each of the one or more target user log features in the first time range, and wherein the analysis occurrences extracted by the database extraction component are occurrences of the one or more analysis user log features in the second time range that are associated with a user in the target user group.

13. The media of claim 11, wherein in the user log data analysis request received by the intake component, the one or more analysis user log features include at least one user log feature different from the one or more target user log features.

14. The media of claim 11, wherein only the occurrences of the one or more target user log features and the occurrences of the one or more analysis user log features not already stored in the feature database are extracted from the one or more user logs by the extraction component.

15. The media of claim 11, wherein the one or more user logs includes a plurality of daily user logs, and wherein the extraction component extracting occurrences of the one or more target user log features and occurrences of the one or more analysis user log features comprises extracting occurrences from two or more of the plurality of daily user logs and merging the occurrences extracted from each daily user log.

16. The media of claim 11, wherein the metadata stored in the feature database for each extracted occurrence include a feature name, time, data source, extracted storage location, and user ID.

17. The media of claim 16, wherein the reformatting component reformats the extracted analysis occurrences into a time-series dataset for each of the users in the target user group, and wherein the reformatting component aggregates one or more of the time-series datasets based on the specified analysis.

18. One or more computer-readable media storing computer-executable instructions for performing a method for efficiently processing user log data, the method comprising:
receiving a user log data analysis request specifying: (1) one or more target user log features and a first time range that identify users in a target user group, (2) one or more analysis user log features and a second time range that identify data associated with the users in the target user group, and (3) an analysis to perform on the identified data associated with the users in the target user group;
upon determining that occurrences of one or more of the target user log features in the first time range or occurrences of one or more of the analysis user log features in the second time range are not already stored, extracting the occurrences not already stored from one or more user logs;
storing the extracted occurrences;
storing metadata describing the extracted and stored occurrences in a feature database, the metadata including a feature name, time, data source, extracted storage location, and user ID;
identifying, as users in the target user group, users with a corresponding user ID associated with at least one occurrence of each of the one or more target user log features in the first time range, the users in the target user group identified from the metadata stored in the feature database;
upon identifying the users in the target user group, extracting stored analysis occurrences, wherein analysis occurrences are occurrences of the analysis user log features in the second time range associated with the user IDs corresponding to the users in the target user group;
for each user in the target user group, reformatting the extracted analysis occurrences into a time-series dataset; and
aggregating the time-series datasets based on the specified analysis.

19. The media of claim 18, wherein the first time range is different from the second time range, and wherein the one or more analysis user log features include at least one user log feature different from the one or more target user log features.

20. The media of claim 18, wherein the one or more user logs includes a plurality of daily user logs, and extracting the occurrences not already stored in the feature database from one or more user logs comprises extracting occurrences from two or more of the plurality of daily user logs and merging the occurrences extracted from each daily user log.
